(19) United States
(12) Patent Application Publication
(10) Pub. No.: US 2026/0260449 A1
(43) Pub. Date: Sep. 3, 2026

(54) INFORMATION PROCESSING METHOD, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventor: Makoto FUJINO, Osaka (JP)

(73) Assignee: PANASONIC INTELLECTUAL PROPERTY MANAGEMENT CO., LTD., Osaka (JP)

(21) Appl. No.: 19/657,479

(22) Filed: Apr. 24, 2026

Related U.S. Application Data
(63) Continuation of application No. PCT/JP2024/038791, filed on Oct. 31, 2024.
(60) Provisional application No. 63/546,974, filed on Nov. 2, 2023.

(30) Foreign Application Priority Data
Jul. 22, 2024 (JP) 2024-116973

(51) Int. Cl. G06V 10/25; G06V 10/74

(52) U.S. Cl. CPC G06V 10/25; G06V 10/761; G06V 2201/07

(57) ABSTRACT

This information processing method is an information processing method performed by a computer and includes displaying a first image and a second image different from the first image on the same screen of a display, detecting a specified region specified by a user and included in the first image, identifying a corresponding region corresponding to the specified region from the second image on the basis of the second image and at least one of image information of the specified region and a positional relationship of the specified region in the first image, and displaying the corresponding region in the second image on the display.

### FIELD OF INVENTION

The present disclosure relates to a technique of displaying an image.

### BACKGROUND ART

A technique described in Patent Literature 1 discloses a skill transmission system including a first eyeglass terminal worn by a first user who is an experienced employee, a second eyeglass terminal worn by a second user who is an unexperienced employee, and a server device. The server device collects information such as a line of sight from the first eyeglass terminal, accumulates the information in a database, performs machine learning by using the accumulated information, and stores information including an attention point of the first user (experienced employee) in the database. Then, when information is input from the second eyeglass terminal worn by the second user (unexperienced employee), the server device extracts the information including the attention point from the database and transmits the information to the second eyeglass terminal. As a result, a screen on which the information related to the attention point of the first user (experienced employee) is displayed in a superimposed manner on the second eyeglass terminal.

Patent Literature 1 merely discloses a technique of displaying an attention point of an experienced employee on an eyeglass terminal worn by an unexperienced employee. Therefore, in the technique described in Patent Literature 1, it is not possible to automatically display a corresponding region corresponding to a specified region arbitrarily specified by a user on a display.

Patent Literature 1: JP 2017-191490 A

### SUMMARY OF THE INVENTION

The present disclosure has been made on the basis of the above problem, and an object of the present disclosure is to provide a technique of allowing automatic display of a corresponding region corresponding to a specified region specified by a user on a display.

An information processing method according to an aspect of the present disclosure is an information processing method performed by a computer and includes displaying a first image and a second image different from the first image on the same screen of a display, detecting a specified region specified by a user and included in the first image, identifying a corresponding region corresponding to the specified region from the second image on the basis of the second image and at least one of image information of the specified region and a positional relationship of the specified region in the first image, and displaying the corresponding region in the second image on the display.

The present disclosure allows the corresponding region corresponding to the specified region specified by the user to be automatically displayed on the display.

### BRIEF DESCRIPTION OF THE DRAWINGS

FIG. 1 is a diagram illustrating an overall configuration of an information processing system according to the present embodiment.

FIG. 2 is a diagram illustrating a design drawing image in which a plurality of imaging point icons is displayed in a superimposed manner.

FIG. 3 is a flowchart illustrating an example of a series of processing in the information processing system.

FIG. 4 is a diagram illustrating an example of a comparison screen.

FIG. 5 is a diagram illustrating the comparison screen in which a first bounding box is superimposed on an annotation region.

FIG. 6 is a diagram illustrating the comparison screen in a case where a plurality of corresponding regions exists.

FIG. 7 is a diagram illustrating a display screen in which a corresponding region selected by a user is displayed in a highlighted manner.

FIG. 8 is a flowchart illustrating a flow of processing in an information processing system according to a second embodiment.

FIG. 9 is a diagram illustrating a design drawing image on which a first visual field range and a second visual field range are mapped.

FIG. 10 is a diagram illustrating a comparison screen according to Modification (1).

### DETAILED DESCRIPTION

### Knowledge Underlying Present Disclosure

A plurality of (for example, two) images may be displayed on the same screen of a display. Then, a user may designate a predetermined region in one of the two images. For example, assuming that a window is drawn in an image, the user may designate a region in which the window is drawn. Hereinafter, the region specified by the user in one of the images is referred to as a specified region. Then, the user may visually recognize the other one of the two images, find a region corresponding to the specified region, and specify a corresponding region corresponding to the specified region. For example, a window corresponding to a window drawn in one image may be found from the other image, and a region in which the corresponding window is drawn may be specified as the corresponding region. As a result, one image including the specified region and the other image including the corresponding region are displayed on the same screen of the display.

However, an operation of visually recognizing the corresponding region from the other image and specifying the corresponding region is complicated. Therefore, this work is desirably automated.

The above problem cannot be solved by the technique disclosed in Patent Literature 1. The technique disclosed in Patent Literature 1 is merely a technique of displaying a region in which an experienced employee pays attention on a terminal of an unexperienced employee. Therefore, a region corresponding to the region specified by the user cannot be automatically displayed on the display.

In order to solve the above problems, the following technique is disclosed.

(1) An information processing method according to an aspect of the present disclosure is an information processing method performed by a computer and includes displaying a first image and a second image different from the first image on the same screen of a display, detecting a specified region specified by a user and included in the first image, identifying a corresponding region corresponding to the specified region from the second image on the basis of the second image and at least one of image information of the specified region and a positional relationship of the specified region in the first image, and displaying the corresponding region in the second image on the display.

In this configuration, in a case where the first image includes the specified region, the corresponding region corresponding to the specified region is identified from the second image on the basis of the second image and at least one of the image information of the specified region and the positional relationship of the specified region in the first image. Then, the corresponding region is displayed on the display. As a result, the corresponding region can be automatically displayed on the display.

In the above configuration, since the first image including the specified region and the second image including the corresponding region are displayed on the same screen of the display, the user can easily compare the specified region and the corresponding region.

(2) In the information processing method according to (1), identifying the corresponding region may include acquiring a first feature amount on the basis of at least one of image information of the specified region and a positional relationship of the specified region in the first image, identifying a corresponding region candidate from the second image on the basis of the first feature amount, acquiring a second feature amount of the corresponding region candidate, determining whether a similarity between the first feature amount and the second feature amount exceeds a threshold value predetermined, and identifying a corresponding region candidate having a second feature amount in which the similarity exceeds the threshold value as the corresponding region.

In this configuration, the corresponding region candidate having the second feature amount in which the similarity with the first feature amount of the specified region is the predetermined threshold value or more is identified as the corresponding region. That is, the corresponding region candidate similar to the specified region is identified as the corresponding region. As a result, the corresponding region can be accurately identified.

(3) In the information processing method according to (2), identifying the corresponding region from the second image may include, in a case where a corresponding region candidate having the second feature amount in which the similarity exceeds the threshold value does not exist in a first display region displayed on the display of the second image, receiving an instruction to display, on the display, a second display region different from the first display region of the second image, and identifying the corresponding region from the second display region.

In this configuration, in a case where a corresponding region candidate having the second feature amount in which the similarity exceeds the threshold value does not exist in the first display region of the second image, the second display region is displayed on the display. Then, the corresponding region is identified from the second display region. As a result, the corresponding region can be more reliably identified.

(4) In the information processing method according to (2) or (3), identifying the corresponding region from the second image may include, in a case where the corresponding region candidate having the second feature amount in which the similarity exceeds the threshold value does not exist in the second image, displaying, on the display as the second image, a substitute image different from an image displayed on the display as the second image, and identifying the corresponding region from the substitute image.

In this configuration, in a case where a corresponding region candidate having the second feature amount in which the similarity exceeds the threshold value does not exist in the second image, the substitute image is displayed on the display. Then, the corresponding region is identified from the substitute image. As a result, the corresponding region can be more reliably identified.

(5) In the information processing method according to any one of (2) to (4), identifying the corresponding region may include, in a case where the corresponding region candidate having the second feature amount in which the similarity exceeds the threshold value does not exist, acquiring first information including an imaging position and an imaging direction when the first image is captured, and an angle of view of a display region of the first image displayed on the display in a left-right direction, acquiring second information including an imaging position, an imaging direction, and an angle of view of the first display region in the left-right direction when the second image is captured, estimating the corresponding region from the second image on the basis of the first information and the second information.

In this configuration, in a case where the corresponding region candidate having the second feature amount in which the similarity exceeds the threshold value does not exist, the corresponding region is estimated on the basis of the imaging position and the imaging direction when the first image is captured, the angle of view in the left-right direction of the display region displayed on the display of the first image, and the imaging position and the imaging direction when the second image is captured, and the angle of view in the left-right direction of the first display region. In this way, the corresponding region can be more reliably displayed on the display.

(6) The information processing method according to any one of (1) to (5) may further include detecting a first object included in the first image, and detecting a second object included in the second image, in which displaying the first image and the second image on the same screen of the display includes distinguishing a region in which the first object is drawn from a region in which the first object is not drawn and displaying the first image on the display, displaying the second image on the display and distinguishing a region in which the second object is drawn from a region in which the second object is not drawn, and thus highlighting that the region in which the first object is drawn and the region in which the second object is drawn are regions to be candidates for the specified region.

In this configuration, since the region to be a candidate for the specified region is presented to the user, the user can easily specify the specified region. As a result, workability of the user is improved.

The present disclosure can be implemented not only as the information processing method of executing the characteristic processing as described above, but also as an information processing device or the like having a characteristic configuration corresponding to the characteristic processing executed by the information processing method. The present disclosure can also be implemented as a computer program that causes a computer to execute the characteristic processing included in the information processing method described above. Therefore, an effect similar to the effect in the above information processing method can also be achieved by other aspects described below.

(7) In an information processing device according to another aspect of the present disclosure including a processor, the processor executes displaying a first image and a second image different from the first image on a same screen of a display, detecting a specified region specified by a user and included in the first image, identifying a corresponding region corresponding to the specified region from the second image on the basis of the second image and at least one of image information of the specified region and a positional relationship of the specified region in the first image, and displaying the corresponding region in the second image on the display.

(8) An information processing program according to still another aspect of the present disclosure causes a computer to execute displaying a first image and a second image different from the first image on a same screen of a display, detecting a specified region specified by a user and included in the first image, identifying a corresponding region corresponding to the specified region from the second image on the basis of the second image and at least one of image information of the specified region and a positional relationship of the specified region in the first image, and displaying the corresponding region in the second image on the display.

The present disclosure can be also implemented as an information processing system that is operated by such an information processing program. In addition, it is needless to say that the present disclosure allows such a program to be distributed using a computer-readable non-transitory recording medium such as a CD-ROM, or via a communication network such as the Internet.

Hereinafter, embodiments of the present disclosure will be described with reference to the drawings. Note that each of the embodiments described below illustrates one specific example of the present disclosure. Numerical values, shapes, components, steps, order of steps, and the like of the embodiments below are merely examples, and are not intended to limit the present disclosure. A component not described in an independent claim representing a highest concept among components in the embodiments below is described as an optional component. In all the embodiments, pieces of content can be combined.

### First Embodiment

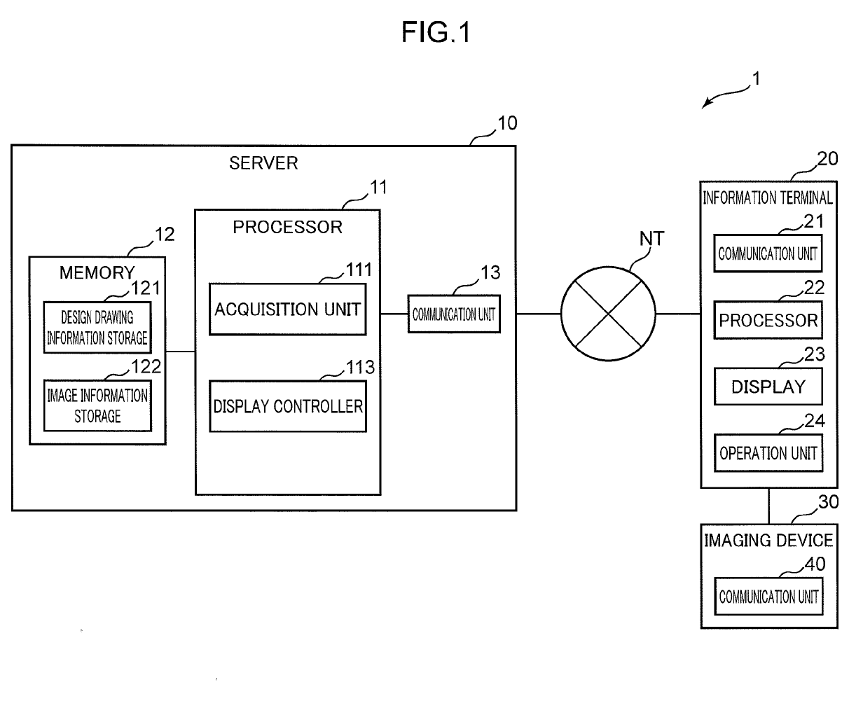

FIG. 1 is a diagram illustrating an overall configuration of an information processing system 1 according to the present embodiment.

When detecting that an annotation region 301 is included in a first image IM1, the information processing system 1 specifies a corresponding region 302 corresponding to the annotation region 301 from a second image IM2 and displays the corresponding region 302 in a highlighted manner on a display. The information processing system 1 includes a server 10, an information terminal 20, and an imaging device 30.

The server 10 is an example of an information processing device and a computer. The server 10, the information terminal 20, and the imaging device 30 are communicably connected to each other via a network NT. An example of the network NT is the Internet. The server 10 is, for example, a cloud server configured by one or a plurality of computers. However, this is an example, and the server 10 may be configured by an edge server or may be implemented in the information terminal 20. An aspect in which the server 10 is implemented in the information terminal 20 is an example of an aspect in which the information terminal 20 is configured by the information processing device.

The information terminal 20 is a terminal operated by a user. The user is, for example, an administrator of a predetermined space imaged by the imaging device 30. The predetermined space is, for example, a construction site. However, this is an example, and the predetermined space may be a building site, a factory, a store, an office, or the like. The information terminal 20 may be configured by, for example, a portable computer such as a smartphone or a tablet computer or may be configured by a stationary computer. Although one information terminal 20 is shown in the example of FIG. 1, a plurality of information terminals may be connected to the server 10 via the network NT. The information terminal 20 includes a communication unit 21, a processor 22, a display 23, and an operation unit 24.

The communication unit 21 is a communication interface that connects the information terminal 20 to the network NT. The communication unit 21 transmits signals indicating various instructions received from the user by the operation unit 24 to the server 10. The communication unit 21 receives display data for displaying various display screens from the server 10.

The processor 22 is configured by, for example, a central processing unit (CPU), and displays the display screen indicated by the display data received by the communication unit 21 on the display 23.

The display 23 is configured by various display devices such as a liquid crystal display or an organic electro-luminescence (EL) display, for example, and displays various display screens under the control of the processor 22.

The operation unit 24 is configured by, for example, a keyboard, a touch panel, a mouse, and the like. The user inputs various instructions by operating the operation unit 24.

The imaging device 30 is configured by, for example, an omnidirectional camera, and captures an image at a predetermined frame rate. The omnidirectional camera is also referred to as a 360 degree camera, and is a camera capable of acquiring an omnidirectional image of 360 degrees. The imaging device 30 is, for example, a portable imaging device carried by a photographer. The photographer is, for example, a worker or a site supervisor at a construction site. Note that the user may be a photographer. The imaging device 30 may capture an image while being held by the hand of the photographer, or may capture an image while being worn on the body (for example, the head) of the photographer. Note that the imaging device 30 may be configured by a normal camera. The imaging device 30 includes a communication unit 40. The communication unit 40 communicably connects the information terminal 20 and the imaging device 30 to each other via a close proximity wireless communication path such as Bluetooth (registered trademark) or a wireless LAN.

The photographer moves in the predetermined space while imaging the construction site with the imaging device 30. When imaging is finished, imaging information including a series of images captured by the imaging device 30 is transferred to the information terminal 20 via the communication unit 40 and temporarily stored in the information terminal 20. The imaging information accumulated in the information terminal 20 is uploaded to the server 10 by the photographer operating the information terminal 20. The imaging information is generated every time one imaging operation is performed. One imaging operation refers to a series of operations from a start of imaging to an end of imaging at a construction site by the photographer.

The imaging information includes a captured image, an imaging start point, an imaging end point, and a design drawing ID corresponding to the predetermined space. The design drawing ID is an identifier that identifies a design drawing of the predetermined space.

The photographer presses an imaging button of the imaging device 30 by directing an imaging direction of the imaging device 30 to a predetermined direction at an imaging start position to start imaging. When the photographer reaches an imaging end point, the photographer presses the imaging button again to end the imaging. The predetermined direction is a direction for matching the direction with the design drawing displayed on the display 23. The predetermined direction is, for example, the north direction, but is not limited thereto.

The imaging start point and the imaging end point are identified by the photographer inputting an instruction to specify the position on a design drawing screen of the predetermined space displayed on the display of the information terminal 20 or the like. Two-dimensional coordinate axes are defined on the design drawing screen. Therefore, the imaging start position and the imaging end position are defined by two-dimensional coordinate values. The imaging start point and the imaging end point are used by the server 10 to specify the position of each imaging point and the imaging direction of each image.

Since the imaging device 30 according to the present embodiment captures an image at a predetermined frame rate (for example, 30 frames per second), the imaging point is defined on a frame period basis. However, in this case, since the data amount becomes enormous, the imaging point may be defined every predetermined time (for example, one second, five seconds, ten seconds, or the like).

The server 10 includes a processor 11, a memory 12, and a communication unit 13. The processor 11 is configured by, for example, a central processing unit (CPU), a graphics processing unit (GPU), or the like. The processor 11 includes an instruction receiver 111, a display controller 112, a detector 113, and an identifier 114. The instruction receiver 111 to the identifier 114 may be implemented by the processor 11 executing the information processing program or may be configured by a dedicated hardware circuit such as an ASIC.

The instruction receiver 111 acquires an instruction by the user input to the information terminal 20. Specifically, in a case where the communication unit 13 receives an instruction signal indicating the instruction transmitted from the information terminal 20, the instruction receiver 111 detects the input of the instruction by the user. The instruction includes, for example, a display instruction for displaying a design drawing image on the display 23 of the information terminal 20, and a selection instruction for selecting one imaging point icon from a plurality of imaging point icons displayed on the design drawing image.

In a case where the instruction receiver 111 acquires the display instruction, the display controller 112 displays the design drawing image on the display 23 of the information terminal 20. The display instruction includes the design drawing ID. The display controller 112 may read the design drawing image indicated by the design drawing ID from a design drawing information storage 121 to be described later and display the design drawing image on the display 23.

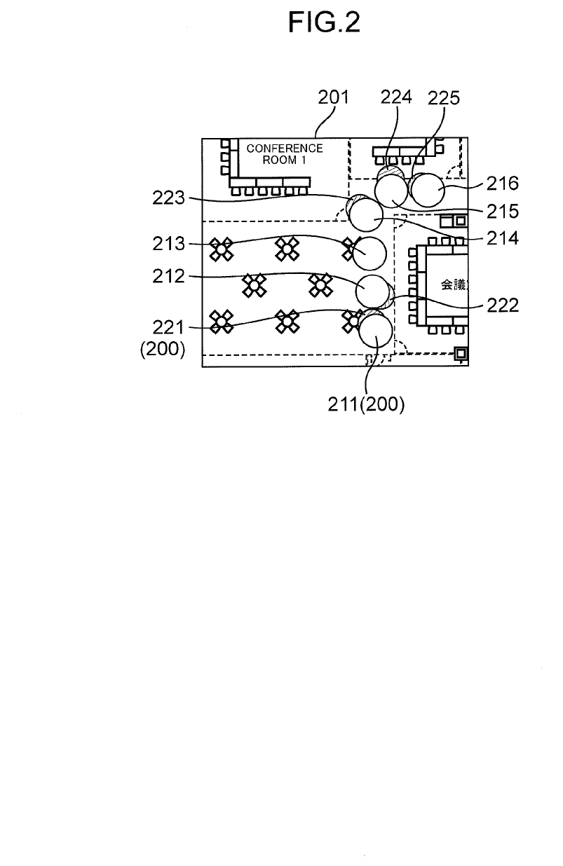

The display controller 112 displays a plurality of imaging point icons 200 in a superimposed manner on the design drawing image. FIG. 2 is a diagram illustrating a design drawing image 201 in which the plurality of imaging point icons 200 is displayed in a superimposed manner. As illustrated in FIG. 2, the imaging point icons include a plurality of first imaging point icons 211 to 216 and a plurality of second imaging point icons 221 to 225.

Each of the plurality of first imaging point icons indicates an imaging point of each of a plurality of images captured by a first imaging operation. These imaging points are identified by the display controller 112. For example, the display controller 112 identifies the imaging point of each image by using a visual simultaneous localization and mapping (SLAM) technology on the basis of the imaging start point, the imaging end point, and the plurality of images included in the imaging information received by the communication unit 13. The imaging point is represented by two-dimensional coordinate values on the design drawing image. The display controller 112 also identifies the imaging direction of each of the plurality of images by using the visual SLAM technology. The imaging direction of each image is represented by, for example, a three-dimensional or two-dimensional polar coordinate vector. Each of the plurality of first imaging point icons is associated with an image captured at the imaging point. Hereinafter, an image associated with the first imaging point icon is referred to as an A image.

Each of the plurality of second imaging point icons indicates an imaging point of each of a plurality of images captured by a second imaging operation. The second imaging operation is an imaging operation performed on a date and time different from a date and time of the first imaging operation (for example, one week later). Similarly to the image captured by the first imaging operation, the imaging point and the imaging direction of each image captured by the second imaging operation are also identified by the VSLAM technology. Similarly to the first imaging point icons, each of the plurality of second imaging point icons is associated with an image captured at the imaging point. Hereinafter, an image associated with the second imaging point icon is referred to as a B image.

When the user inputs an operation of selecting any one of the plurality of imaging point icons illustrated in FIG. 2, the display controller 112 displays the A image and the B image on the same screen of the display 23. For example, it is assumed that the information terminal 20 receives an instruction (selection instruction) to select the first imaging point icon from the user. In this case, the display controller 112 displays the A image associated with the first imaging point icon selected by the user on the display 23. Next, the display controller 112 identifies a second imaging point icon drawn at a position closest to the first imaging point icon selected by the user. Then, the B image associated with the identified second imaging point icon is displayed on the display 23. The display controller 112 displays, on the display 23 together with the A image, the B image captured on a date and time (for example, one week later) that is different from the date and time when the A image was captured and is captured from a similar imaging point to the imaging point where the A image was captured.

In a case where the information terminal 20 receives an instruction to select the second imaging point icon, the display controller 112 displays the image B associated with the second imaging point icon selected by the user on the display 23. Then, the A image associated with the first imaging point icon drawn at a position closest to the second imaging point icon selected by the user is displayed on the display 23.

In the present embodiment, when the A image and the B image are displayed on the display 23, the user inputs a region specification instruction to specify a predetermined region in the A image or the B image through the operation unit 24. Hereinafter, the region specified by the user is referred to as the annotation region 301 (an example of a specified region). Hereinafter, an image including the annotation region 301 is referred to as the first image IM1, and an image not including the annotation region 301 is referred to as the second image IM2. That is, an image displayed on the same screen as the first image IM1 and different from the first image IM1 is referred to as the second image IM2. For example, in a case where the user inputs a region specification instruction to set the annotation region 301 to a predetermined region in the A image, the A image is relevant to the first image IM1 and the B image is relevant to the second image IM2.

The information terminal 20 that has received the region specification instruction from the user transmits the region specification instruction to the server 10. Then, when the server 10 receives the region specification instruction, the display controller 112 displays a frame such as a bounding box surrounding the annotation region 301 specified by the user in a superimposed manner on the first image IM1.

In a case where the identifier 114 specifies the corresponding region 302 from the second image IM2, the display controller 112 displays the corresponding region 302 on the display 23. “Displaying the corresponding region 302 on the display 23” includes displaying the corresponding region 302 on the display 23 in a highlighted manner. “Displaying the corresponding region 302 on the display 23” includes displaying the corresponding region 302 on the display 23 by switching a display region of the second image IM2 to a second display region (described later) in a case where the corresponding region 302 does not exist in a first display region (described later) of the second image IM2. Furthermore, “displaying the corresponding region 302 on the display 23” includes displaying another image on the display 23 as the second image in a case where the corresponding region does not exist in an image currently displayed on the display 23 as the second image IM2, and displaying the corresponding region 302 included in the another image on the display 23. Details will be described later.

The detector 113 detects the annotation region 301 by the user included in the first image IM1. That is, the detector 113 detects that the annotation region 301 is included in the A image or the B image.

The identifier 114 identifies the corresponding region 302. The corresponding region 302 is a region included in the second image IM2 and is a region corresponding to the annotation region 301.

The identifier 114 identifies the corresponding region 302 from the second image IM2 on the basis of at least one of image information of the annotation region 301 and a positional relationship of the annotation region 301 in the first image IM1 and on the basis of the second image IM2.

The image information of the annotation region 301 is, for example, a color, a shape, and a size of an object included in the annotation region 301. The color, shape, and size of the object included in the annotation region 301 can be acquired by extracting the annotation region 301 and performing object recognition processing, boundary recognition processing, and the like on this region.

The positional relationship of the annotation region 301 in the first image IM1 refers to a positional relationship between one or more objects included in the first image IM1 and the annotation region 301.

The memory 12 is configured by a nonvolatile rewritable storage device such as a hard disk drive or a solid-state drive. The memory 12 includes the design drawing information storage 121 and an imaging information storage 122.

The design drawing information storage 121 stores design drawing information. The design drawing information is image information indicating the design drawing of the predetermined space. The design drawing information is associated with a design drawing ID for identifying the design drawing. The design drawing is a diagram illustrating a design of the predetermined space, and is, for example, a plan view, a blueprint, a map, a perspective view, a bird’s eye view, or the like of the predetermined space. The bird’s eye view can also be referred to as an overhead view, and may be a view from above or a diagram viewed from high above.

The imaging information storage 122 stores the imaging information transmitted from the imaging device 30. As described above, the imaging information includes a captured image, an imaging start points, an imaging end point, and a design drawing ID corresponding to the predetermined space. The imaging information storage 122 also stores meta information associated with an image included in the imaging information. The meta information includes an imaging ID, an imaging direction, an imaging point (an example of an imaging position), and imaging date and time. The imaging ID is an identifier of the imaging point. The imaging point is position information (two-dimensional coordinate value) indicating the imaging point of the image. The imaging direction is the imaging direction of the imaging device 30 that has captured the image. The imaging date and time is, for example, information indicating a date and time when an image is captured. The meta information is generated every time the imaging information described above is transmitted.

The communication unit 13 is a communication interface that connects the server 10 to the network.

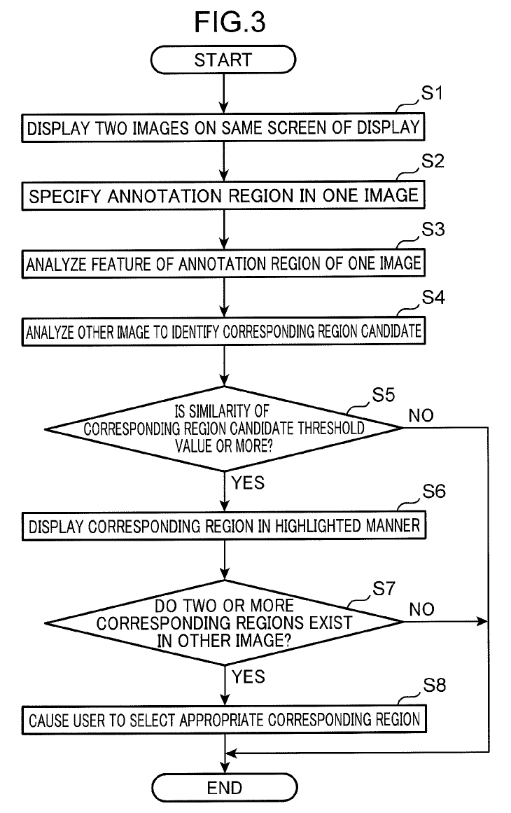

Next, the processing of the information processing system 1 will be described. FIG. 3 is a flowchart illustrating an example of a series of processing in the information processing system 1. The flowchart of FIG. 3 starts, for example, when the user selects an arbitrary imaging point icon from the design drawing image 201 (FIG. 2) displayed on the display 23. Hereinafter, the processing of the information processing system 1 will be described by exemplifying a case where the user selects the first imaging point icon 211 illustrated in FIG. 2.

In step S1, the display controller 112 displays two images on the same screen of the display 23. Specifically, the display controller 112 displays the A image associated with the first imaging point icon 211 and the B image associated with the second imaging point icon 221 drawn at a position closest to the first imaging point icon 211 on the same screen of the display 23. Hereinafter, the screen on which the A image and the B image are displayed is referred to as a comparison screen 300.

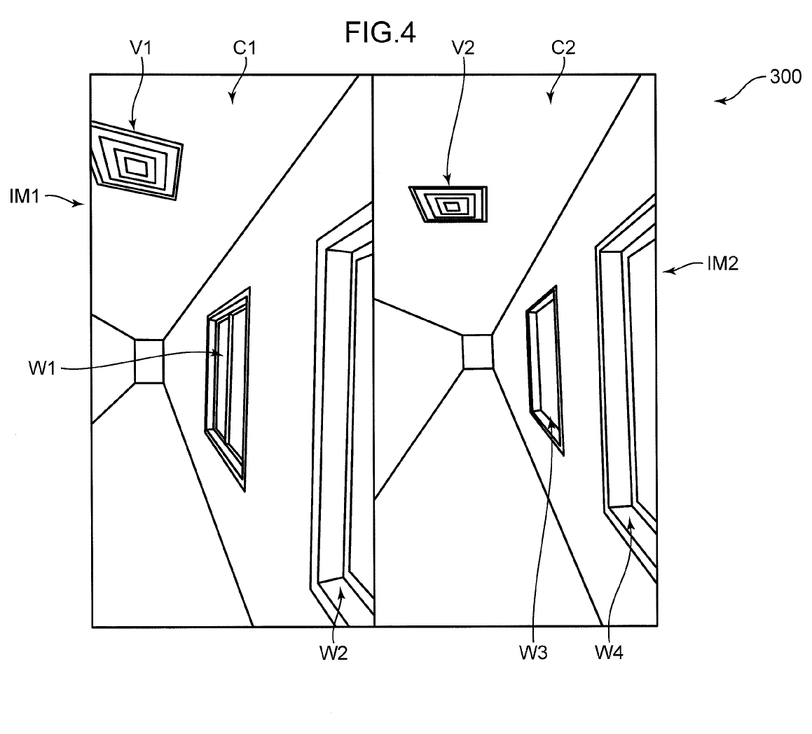

FIG. 4 is a diagram illustrating an example of the comparison screen 300. In the example illustrated in FIG. 4, the A image is displayed in the left half of the comparison screen 300, and the B image is displayed in the right half of the comparison screen 300. As illustrated in FIG. 4, the A image includes objects of a plurality of windows, an object of a ventilator, and an object of a ceiling. Hereinafter, these objects are referred to as a first window object W1, a second window object W2, a first ventilator object V1, and a first ceiling object C1, respectively. The B image includes objects of a plurality of windows, an object of a ventilator, and an object of a ceiling. Hereinafter, these objects are referred to as a third window object W3, a fourth window object W4, a second ventilator object V2, and a second ceiling object C2, respectively. Note that the objects included in the A image and the B image are not limited to the above example. For example, objects of structures such as floors and columns, objects other than structures such as desks and chairs, and other characteristic objects may be included in the A image and the B image.

Referring to FIG. 3 again, in step S2, the user specifies the annotation region 301 in one of the two images of the A image or the B image. That is, in step S2, the information terminal 20 receives the region specification instruction from the user. Hereinafter, as an example, it is assumed that the user specifies a region in which the first window object W1 is drawn in the A image as the annotation region 301. The user specifies the annotation region 301, for example, by performing a so-called drag operation. In this case, the A image is relevant to the first image IM1, and the B image is relevant to the second image IM2.

When receiving the region specification instruction, the information terminal 20 may receive an input of metadata to be given to the annotation region 301. For example, input of a comment to be given to the annotation region 301, a class label indicating a status of the annotation region 301, and the like may be received. Specifically, input of a comment such as “inspection completed on April 1” or “temporarily installed on April 1” or a label indicating a status such as “work completed”, “working”, or “not started” may be received.

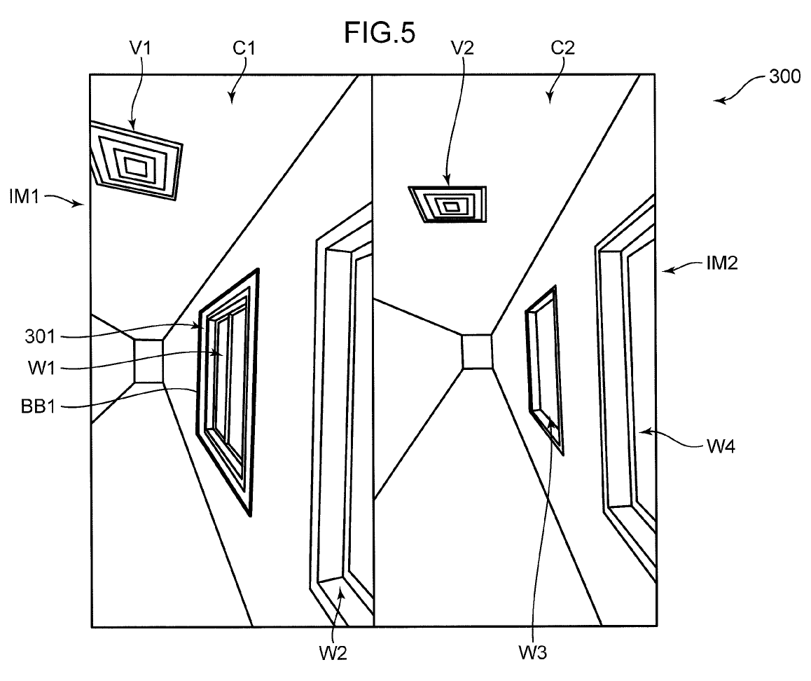

In step S2, the information terminal 20 that has received the region specification instruction from the user transmits this instruction to the server 10. Then, when the communication unit 13 of the server 10 receives the region specification instruction, the display controller 112 recognizes the annotation region 301 specified by the user. Then, the display controller 112 displays the annotation region 301 in a highlighted manner by superimposing a frame such as a bounding box on the annotation region 301. FIG. 5 is a diagram illustrating the comparison screen 300 in which a first bounding box BB1 is superimposed on the annotation region 301. As described above, the user specifies a region in which the first window object W1 is drawn as the annotation region 301. Therefore, the first bounding box BB1 surrounding the first window object W1 is displayed in a superimposed manner on the first image IM1 illustrated in FIG. 5.

Referring to FIG. 3 again, in step S3, the identifier 114 analyzes a feature of the annotation region 301 of the first image IM1 (one of the images). In step S3, first, the detector 113 detects that the annotation region 301 is included in the first image IM1. Subsequently, the identifier 114 acquires a first feature amount indicating the feature of the annotation region 301 on the basis of at least one of the image information of the annotation region 301 and the positional relationship of the annotation region 301.

In a case where the first feature amount is acquired on the basis of the image information of the annotation region 301, the identifier 114 extracts the annotation region 301 from the first image IM1. Then, the extracted annotation region 301 is input to an image recognition model (not illustrated) created in advance by machine learning. The image recognition model executes the object recognition processing and the boundary recognition processing on the annotation region 301. As a result, the image recognition model recognizes the color, shape, size, and the like of the first window object W1 included in the annotation region 301. Then, the image recognition model converts the color, shape, size, and the like of the first window object W1 into a feature vector. The image recognition model then outputs this feature vector. Then, the identifier 114 acquires the feature vector output from the image recognition model as the first feature amount.

In a case where the first feature amount is acquired on the basis of the positional relationship of the annotation region 301, the identifier 114 inputs the first image IM1 to an image recognition model (not illustrated) created in advance by machine learning. Then, the image recognition model performs predetermined image recognition processing on the first image IM1. As a result, the image recognition model recognizes the position of the annotation region 301 in the first image IM1 and the position of the object included in the first image IM1 in the first image IM1. Then, the image recognition model recognizes a positional relationship between the position of the annotation region 301 and the position of the object.

The positional relationship is defined by an offset amount of the annotation region 301 with respect to the object and a relative offset direction of the annotation region 301 with respect to the object. Specifically, the identifier 114 recognizes that a distance between a center of the annotation region 301 and a center of the first ventilator object V1 (FIG. 5) is, for example, 100 pixels. The identifier 114 recognizes that an angle formed by a reference line passing through the center of the annotation region 301 and extending in parallel to a left-right direction of the display 23 and a virtual straight line extending from the center of the annotation region 301 to the center of the first ventilator object V1 is, for example, 100 degrees. That is, it is recognized that the annotation region 301 is located in a lower right direction with respect to the first ventilator object V1 in the first image IM1. Similarly, the image recognition model recognizes that a distance between the center of the annotation region 301 and a center of the first ceiling object C1 (FIG. 5) is, for example, 70 pixels. The identifier 114 recognizes that an angle formed by the reference line and a virtual straight line extending from the center of the annotation region 301 to the center of the first ceiling object C1 is, for example, 120 degrees. That is, it is recognized that the annotation region 301 is located in the lower right direction with respect to a central portion of the first ceiling object C1 in the first image IM1. Furthermore, the image recognition model recognizes that a distance between the center of the annotation region 301 and a center of the second window object W2 (FIG. 5) is, for example, 20 pixels. The identifier 114 recognizes that an angle formed by the reference line and a virtual straight line extending from the center of the annotation region 301 to the center of the second window object W2 is, for example, 350 degrees. That is, it is recognized that the annotation region 301 is located in a left direction with respect to the second window object W2 in the first image IM1. As described above, the image recognition model recognizes a positional relationship between the positions of various objects appearing in the first image IM1 and the position of the annotation region 301. The image recognition model converts the positional relationship into a feature vector and outputs the feature vector. Then, the identifier 114 acquires the feature vector output from the image recognition model as the first feature amount.

In step S4, the identifier 114 analyzes the other image, that is, the second image IM2, and identifies a corresponding region candidate. The corresponding region candidate is one or more regions that are candidates for the corresponding region 302. The identifier 114 identifies a corresponding region candidate from the second image IM2 on the basis of the first feature amount.

It is assumed that a feature vector indicating the color, shape, size, and the like of the first window object W1 is acquired as the first feature amount in step S3. In this case, the identifier 114 identifies, as the corresponding region candidate, a region in which an object having similar color, shape, and size to those of the first window object W1 is drawn. For example, the identifier 114 identifies a region in which the third window object W3 is drawn in the second image IM2 as the corresponding region candidate. The identifier 114 having identifies the corresponding region candidate acquires a second feature amount indicating a feature of the corresponding region candidate. For example, the identifier 114 extracts the corresponding region candidate from the second image IM2 and inputs the extracted corresponding region candidate to the image recognition model. As a result, the color, shape, and size of the third window object W3 are converted into a feature vector. Then, the identifier 114 acquires the feature vector as the second feature amount.

In a case where the feature vector indicating the positional relationship between the position of the annotation region 301 and the position of the object is acquired as the first feature amount in step S3, the identifier 114 identifies the corresponding region candidate on the basis of the positional relationship. First, the identifier 114 executes the image recognition processing on the second image IM2 and recognizes an object appearing in the second image IM2. Then, a correspondence relationship between the object included in the second image IM2 and the object included in the first image IM1 is recognized. For example, the identifier 114 recognizes that the second ventilator object V2 of the second image IM2 corresponds to the first ventilator object V1 of the first image IM1, that the second ceiling object C2 of the second image IM2 corresponds to the first ceiling object C1 of the first image IM1, and that the fourth window object W4 of the second image IM2 corresponds to the second window object W2 of the first image IM1. Next, in the second image IM2, the identifier 114 identifies, as the corresponding region candidate, a region that exists at a position 100±α pixels away in the lower right direction from the center of the second ventilator object V2, exists at a position 70±β pixels away in the lower right direction from the center of the second ceiling object C2, and exists at a position 20±γ pixels away in the left direction from the center of the fourth window object W4. The values of α, β, and γ may be appropriately set.

For example, the identifier 114 identifies a region in which the third window object W3 is drawn in the second image IM2 as the corresponding region candidate. Then, the identifier 114 acquires the second feature amount indicating the feature of the corresponding region candidate. The identifier 114 acquires, as the second feature amount, a feature vector indicating a positional relationship between the positions of various objects appearing in the second image IM2 and the position of the corresponding region candidate.

In step S5, the identifier 114 determines whether a similarity of the corresponding region candidate is a predetermined threshold value or more. Specifically, the identifier 114 calculates the similarity between the first feature amount (feature vector) of the annotation region 301 and the second feature amount (feature vector) of the corresponding region candidate, and determines whether the similarity is a reference similarity or more. The identifier 114 may calculate the similarity between the feature vectors by calculating, for example, a cosine distance or the like.

In step S5, in a case where the similarity of the corresponding region candidate is the predetermined threshold value or more (YES in step S5), the identifier 114 identifies the corresponding region candidate as the corresponding region 302. Then, the processing proceeds to step S6. On the other hand, in a case where the similarity of the corresponding region candidate is less than the predetermined threshold value (NO in step S5), the processing ends.

In step S6, the display controller 112 displays the corresponding region 302 identified by the identifier 114 on the display 23. Specifically, the display controller 112 displays the corresponding region 302 on the display 23 in a highlighted manner. That is, the display controller 112 distinguishes the corresponding region 302 in the second image IM2 from a region different from the corresponding region 302 in the second image IM2 and displays the corresponding region 302 on the display 23. For example, the display controller 112 superimposes a frame such as a bounding box surrounding the corresponding region 302 on the second image IM2. In addition, the display controller 112 may change the color or the like of the corresponding region 302. In this way, the display controller 112 displays the corresponding region 302 in a highlighted manner.

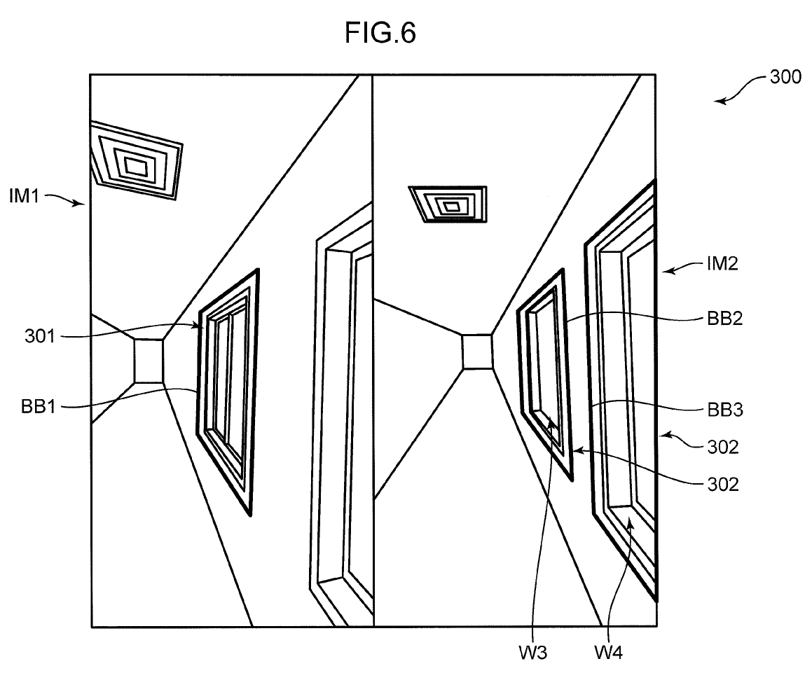

Meanwhile, a plurality of corresponding regions 302 may exist. In other words, a plurality of corresponding region candidates having a similarity of a predetermined threshold value or more with the annotation region 301 of the first image IM1 can exist. For example, it is assumed that a region in which the third window object W3 is drawn and a region in which the fourth window object W4 is drawn in the second image IM2 are identified as the corresponding regions 302. In this case, the display controller 112 displays the plurality of corresponding regions 302 on the display 23 in a highlighted manner. FIG. 6 is a diagram illustrating the comparison screen 300 in a case where the plurality of corresponding regions 302 exists. In the example illustrated in FIG. 6, the region in which the third window object W3 is drawn and the region in which the fourth window object W4 is drawn are displayed in a highlighted manner. Specifically, a region in which the third window object W3 is drawn is surrounded by a second bounding box BB2, and a region in which the fourth window object W4 is drawn is surrounded by a third bounding box BB3.

In step S7, the detector 113 determines whether two or more corresponding regions 302 exist in the other image, that is, the second image IM2. The detector 113 analyzes, for example, a processing history of the identifier 114. Then, in a case of confirming the processing history indicating that the identifier 114 has identified the plurality of corresponding regions 302, the detector 113 determines that the plurality of corresponding regions 302 exists in the second image IM2.

In a case where a plurality of corresponding regions 302 exists in the second image IM2 (YES in step S7), the processing proceeds to step S8. On the other hand, in a case where the plurality of corresponding regions 302 does not exist in the second image IM2 (NO in step S7), the processing ends.

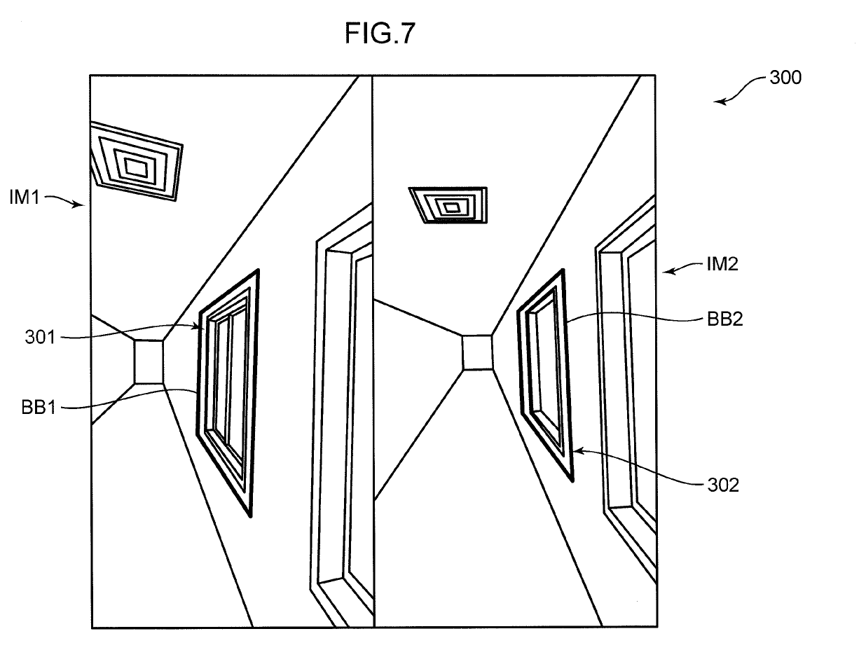

In step S8, the information terminal 20 causes the user to select an appropriate corresponding region 302. That is, the information terminal 20 receives an instruction to select an appropriate corresponding region 302 from the user. For example, it is assumed that the user selects a region in which the third window object W3 is drawn as the appropriate corresponding region 302. The information terminal 20 that has received this operation transmits the selection result of the user to the server 10. Then, the display controller 112 displays the corresponding region 302 selected by the user in a highlighted manner. FIG. 7 is a diagram illustrating the comparison screen 300 in which the corresponding region 302 selected by the user is displayed in a highlighted manner. As described above, the user selects a region in which the third window object W3 is drawn as the appropriate corresponding region 302. Therefore, in the example illustrated in FIG. 7, the display controller 112 displays the second bounding box BB2 surrounding the third window object W3 in a superimposed manner on the second image IM2. The display controller 112 deletes the third bounding box BB3 (FIG. 6).

Note that, in step S8, in a case where the user confirms that an appropriate region is not identified as the corresponding region 302, the user may input an instruction to adjust the position, range, and the like of the bounding box in the second image IM2.

Furthermore, in a case where metadata is given to the annotation region 301 in step S2, the display controller 112 associates the metadata with the corresponding region 302 in step S8. As an example, it is assumed that a region in which the first window object W1 is drawn is specified as the annotation region 301, and a comment such as “temporarily installed on April 1” or a label (metadata) such as “working” is given to this region. Here, it is assumed that a region in which the third window object W3 is drawn is identified as the corresponding region 302. In this case, the display controller 112 associates the metadata given to the first window object W1 with the corresponding region 302. In step S8, the information terminal 20 may receive the input of the metadata given to the corresponding region 302 from the user. For example, an instruction to give a comment such as “completion of installation on April 8” or a label such as “work completed” to the region (corresponding region 302) in which the third window object W3 is drawn may be received. In this case, the display controller 112 associates the metadata given to the corresponding region 302 with the annotation region 301. In this way, the content of the metadata given to the annotation region 301 is reflected in the corresponding region 302, and the content of the metadata given to the corresponding region 302 is reflected in the annotation region 301. For example, when the comment related to the annotation region 301 is edited, the editing result is also reflected in the comment of the corresponding region. As a result, workability of the user is improved.

In the information processing system 1 described above, in a case where the annotation region 301 is included in the first image IM1, the corresponding region 302 corresponding to the annotation region 301 is identified from the second image IM2 on the basis of the second image IM2 and at least one of the image information of the annotation region 301 and the positional relationship of the annotation region 301 in the first image IM1. Then, the corresponding region 302 is displayed on the display 23 in a state of being distinguished from a region different from the corresponding region 302 in the second image IM2. As a result, the corresponding region 302 can be automatically displayed on the display 23.

Moreover, in the above configuration, since the first image IM1 including the annotation region 301 and a second region AR2 including the corresponding region 302 are displayed on the same screen of the display 23, the user can easily compare the annotation region 301 and the corresponding region 302.

The information processing system 1 according to the present embodiment is useful because before and after corresponding to the problem become clear. For example, it is assumed that a shelf attached with a bolt loosened appears in the first image. Then, it is assumed that the user specifies a region in which the shelf is drawn in the first image as the annotation region. It is assumed that the second image captured at a similar imaging point and imaging direction one week after the first image is displayed on the same screen as the first image. Here, when the corresponding region 302 is automatically picked up from the second image, the operator can easily confirm whether the bolt remains loosened after one week. As described above, in the information processing system, it is difficult to make a mistake of before and after corresponding to the problem.

Furthermore, in a case where the user visually finds the corresponding region 302, there is a possibility that a wrong region is specified as the corresponding region 302 due to the user’s mistake or the like. However, in the present embodiment, since the corresponding region 302 is automatically displayed on the display 23, it is possible to prevent the wrong region from being specified as the corresponding region 302.

In the information processing system 1 according to the present embodiment, a corresponding region candidate similar to the annotation region 301 is identified as the corresponding region 302. As a result, the corresponding region 302 can be accurately identified.

### Second Embodiment

An information processing system 1A according to a second embodiment will be described. In the first embodiment, an example has been described in which the processing ends in a case where a corresponding region candidate having a similarity of the predetermined threshold value or more does not exist. On the other hand, in the second embodiment, in a case where a corresponding region candidate having the similarity of the predetermined threshold value or more does not exist, the corresponding region candidate having the similarity of the predetermined threshold value or more is identified by performing additional processing. In the second embodiment, similar components to those in the first embodiment are denoted by the same reference numerals, and description thereof will be omitted.

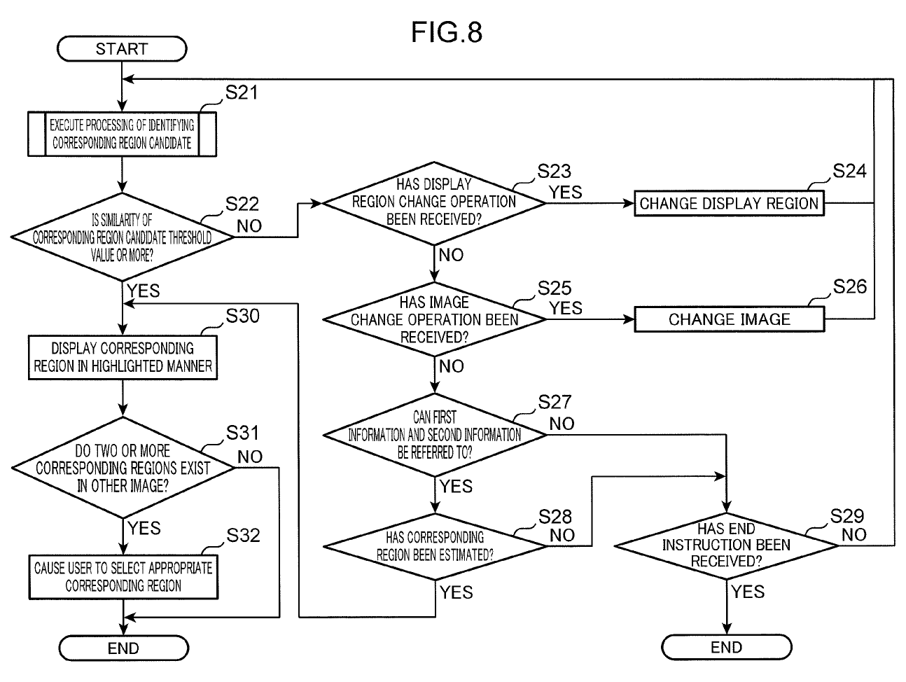

FIG. 8 is a flowchart illustrating a flow of processing in the information processing system 1A according to the second embodiment. The flowchart illustrated in FIG. 8 starts, as in the first embodiment, when the user selects an arbitrary imaging point icon from the design drawing image (FIG. 2) displayed on the display 23.

In step S21, processing of specifying a corresponding region candidate is performed. Since the processing related to step S21 is similar to the processing described in steps S1 to S4 in FIG. 3 in the first embodiment, the description thereof is omitted.

In step S22, the identifier 114 determines whether similarity of the corresponding region candidate is a predetermined threshold value or more. As in the processing in step S5 in the first embodiment, the identifier 114 calculates the similarity between the first feature amount of the annotation region 301 and the second feature amount of the corresponding region candidate, and determines whether the similarity is a reference similarity or more.

In step S22, in a case where the similarity of the corresponding region candidate is the predetermined threshold value or more (YES in step S22), the identifier 114 identifies the corresponding region candidate as the corresponding region 302. Then, the processing proceeds to step S29. On the other hand, in a case where the similarity of the corresponding region candidate is less than the predetermined threshold value (NO in step S22), the processing proceeds to step S23.

In step S23, the display controller 112 determines whether the information terminal 20 has received a display region change operation. As described above, both the first image IM1 and the second image IM2 displayed on the same screen of the display 23 are images captured by the 360 degree camera. Incidentally, it is difficult to display the entire image captured by the 360 degree camera on the display 23 at a time due to its characteristics. Therefore, for example, when the second image IM2 is displayed on the display 23, a partial region is extracted from the entire second image IM2, and this partial region is displayed on the display 23. Hereinafter, a region that is a part of the second image IM2 and is currently displayed on the display 23 is referred to as a first display region. Then, even if the corresponding region 302 is not included in the first display region, there is a possibility that the corresponding region 302 is included in a region in the second image IM2 that is not currently displayed on the display 23. Hereinafter, a region of the second image IM2 that is different from the first display region and is not currently displayed on the display 23 is referred to as a second display region.

Therefore, in step S23, first, the information terminal 20 displays, on the display 23, a predetermined user interface for receiving the display region change operation from the user. The display region change operation is an operation input by the user to the information terminal 20, and is an operation of inputting an instruction to display the second display region instead of the first display region. For example, it is an operation of rotating a display direction of an image by a predetermined rotation amount from a display direction of the image currently displayed on the display 23 to another display direction. Then, in step S23, the display controller 112 determines whether the information terminal 20 has received the display region change operation from the user.

In a case where the information terminal 20 has received the display region change operation (YES in step S23), the processing proceeds to step S24.

In step S24, the display controller 112 changes the region of the second image IM2 to be displayed on the display 23 from the first display region to the second display region in response to the display region change operation input by the user. Then, the processing returns to step S21, and the identifier 114 identifies the corresponding region 302 from the second display region through the processing of steps S21 and S22. In a case where the corresponding region 302 does not exist in the second display region (NO in step S22) and the display region change operation is received again in step S23 (YES in step S23), the display controller 112 may display a region different from the first display region and the second display region on the display 23.

In a case where the information terminal 20 has not received the display region change operation (NO in step S23), the processing proceeds to step S25. In step S25, the display controller 112 determines whether an image change operation has been received. The image change operation is an operation input by the user to the information terminal 20, and is an operation of inputting an instruction to display an image different from the second image IM2 currently displayed on the display 23 on the display 23 as the second image IM2.

Even if the corresponding region 302 does not appear in the second image IM2, there is a possibility that the corresponding region 302 appears in an image captured from an imaging point different from the second image IM2. In particular, the 360 degree camera according to the present embodiment is a camera that captures an image at a predetermined frame rate. Therefore, the imaging information storage 122 stores an image captured near the imaging point where the second image IM2 is captured.

Therefore, in step S25, first, the information terminal 20 displays, on the display 23, a predetermined user interface for receiving the image change operation from the user. For example, the information terminal 20 displays the design drawing image 201 illustrated in FIG. 2 on the display 23 again. As a result, the user is prompted to select an image captured at an imaging point different from the second image IM2. Then, the display controller 112 determines whether the information terminal 20 has received the image change operation from the user.

In a case where the information terminal 20 has received the image change operation (YES in step S25), the processing proceeds to step S26. In step S26, the display controller 112 changes the image to be displayed on the display 23 in response to the image change operation of the user. Specifically, an image (hereinafter, referred to as a substitute image) different from the image displayed as the second image IM2 on the display 23 is displayed as the second image IM2 on the display 23. For example, it is assumed that the user selects the second imaging point icon 222 (FIG. 2). In this case, the display controller 112 causes the display 23 to newly display the B image (substitute image) associated with the second imaging point icon 222 as the second image IM2. Then, the processing returns to step S21, and the identifier 114 identifies the corresponding region 302 from the substitute image through the processing of steps S21 and S22.

In a case where the information terminal 20 has not received the image change operation (NO in step S25), the processing proceeds to step S27. In step S27, the identifier 114 determines whether the first information and the second information can be referred to.

The first information is information including an imaging position and an imaging direction when the first image IM1 is captured, and an angle of view of the display region of the first image IM1 currently displayed on the display 23 in the left-right direction. The imaging position and the imaging direction when the first image IM1 is captured are stored in the imaging information storage 122 as meta information. The angle of view in the left-right direction of the display region of the first image IM1 currently displayed on the display 23 is determined in advance by the display controller 112 when the first image IM1 is displayed on the display 23.

The second information is information including an imaging position and an imaging direction when the second image IM2 is captured, and an angle of view of the display region (first display region) of the second image IM2 currently displayed on the display 23 in the left-right direction. Similarly to the first information, the imaging position and the imaging direction of the second image IM2 are stored in the imaging information storage 122 as meta information. The angle of view in the left-right direction of the first display region is determined in advance by the display controller 112 when the second image IM2 is displayed on the display 23.

In a case where the first information and the second information can be referred to (YES in step S27), the processing proceeds to step S28. On the other hand, in a case where the first information and the second information cannot be referred to because the meta information stored in the imaging information storage 122 is damaged, for example (NO in step S27), the processing proceeds to step S29.

In a case where it is determined as YES in step S27, in step S28, the identifier 114 determines whether the corresponding region 302 has been estimated from the second image IM2 on the basis of the first information and the second information. Details will be described below.

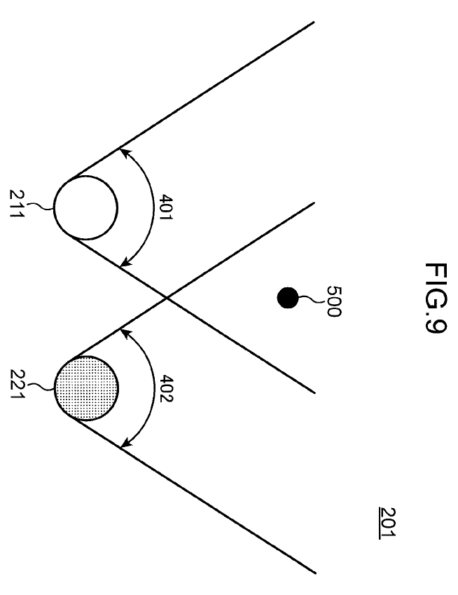

First, the identifier maps a first visual field range 401 and a second visual field range 402 on the design drawing image 201. FIG. 9 is a diagram illustrating the design drawing image 201 on which the first visual field range 401 and the second visual field range 402 are mapped.

For example, by using the imaging position and the imaging direction of the first image IM1 and the angle of view in the left-right direction of the display region (hereinafter, referred to as a third display region) currently displayed on the display 23 of the first image IM1, the identifier 114 maps the first visual field range 401, which is a visual field range of the third display region, on the design drawing image 201. The first visual field range 401 is a fan-shaped region extending in the imaging direction from the imaging position of the first image IM1, and is a region in which a viewing angle is defined by the angle of view in the left-right direction of the third display region.

Similarly, the identifier 114 maps the second visual field range 402, which is a visual field range of the first display region, on the design drawing image 201 by using the imaging position and the imaging direction of the second image IM2 and the angle of view of the first display region in the left-right direction. The second visual field range 402 is a fan-shaped region extending in the imaging direction from the imaging position of the second image IM2, and is a region in which a view angle is defined by the angle of view in the left-right direction of the first display region.

Subsequently, the identifier 114 maps an annotation position 500 on the design drawing image 201. The annotation position 500 is a position of the annotation region 301 in the first visual field range 401. The annotation position 500 is identified by using, for example, a relative position of the annotation region 301 with respect to the third display region.

Then, the identifier 114 determines whether the annotation position 500 is included in the second visual field range 402 mapped on the design drawing image 201. In a case of determining that the annotation position 500 is included in the second visual field range 402, the identifier 114 specifies the region of the annotation position 500 in the first display region of the second image IM2 from a relative position of the annotation position 500 with respect to the imaging point of the second image IM2. In this method, there is a possibility that the position in an up-down direction cannot be identified although the position in the left-right direction of the annotation position 500 in the first display region can be identified. That is, assuming that an X coordinate corresponding to a horizontal width of the display 23 and a Y coordinate corresponding to a vertical width of the display 23 are set in the first display region, there is a possibility that a Y coordinate of the annotation position 500 cannot be identified even if an X coordinate of the annotation position 500 can be identified. Therefore, the identifier 114 sets the position of the annotation position 500 in the first display region in the up-down direction to the same position as the annotation position 500 in the third display region in the up-down direction. Then, the identified region is estimated as the corresponding region 302. In a case where the corresponding region 302 can be estimated as described above, the identifier 114 determines YES in step S28. Then, the processing proceeds to step S30.

On the other hand, in a case where the corresponding region 302 cannot be estimated because the annotation position 500 is not included in the second visual field range 402 mapped on the design drawing image 201, or the like, the identifier 114 determines NO in step S28. In this case, the processing proceeds to step S29.

In step S29, the identifier 114 determines whether the user has input an end instruction that is an instruction to stop the processing of identifying the corresponding region. In a case where the end instruction has been input (YES in step S29), the processing ends. In a case where the end instruction has not been input (NO in step S29), the processing returns to step S21.

Since the processing from step S30 to step S32 is similar to the processing from step S6 to step S8 described in the first embodiment, the description thereof is omitted.

In the information processing system 1A described above, in a case where a corresponding region candidate having the second feature amount in which the similarity exceeds the threshold value does not exist in the first display region of the second image IM2, the second display region is displayed on the display 23. Then, the corresponding region 302 is identified from the second display region. Therefore, the corresponding region 302 can be more reliably identified.

In the information processing system 1A, in a case where a corresponding region candidate having the second feature amount in which the similarity exceeds the threshold value does not exist in the second image IM2, the substitute image is displayed on the display 23. Then, the corresponding region 302 is identified from the substitute image. Therefore, the corresponding region 302 can be more reliably identified.

In the information processing system 1A, in a case where a corresponding region candidate having the second feature amount in which the similarity exceeds the threshold value does not exist, the corresponding region 302 is estimated on the basis of the imaging position and the imaging direction when the first image IM1 is captured and the imaging position and the imaging direction when the second image IM2 is captured. Therefore, the corresponding region 302 can be more reliably displayed on the display 23.

A modification below can be employed for the present disclosure.

(1) In the first embodiment, an example in which the user specifies the annotation region 301 by performing a so-called drag operation has been described. However, the method of specifying the annotation region 301 is not limited to this example, and the annotation region may be specified by the following method.

In general, the user often specifies a region in which an object is drawn as the annotation region 301. Therefore, in this modification, the display controller 112 recognizes an object included in the image, and displays the object in a highlighted manner as a candidate region (hereinafter, referred to as an annotation region candidate) of the annotation region 301. In this way, the user can specify the annotation region by selecting the annotation region candidate. Therefore, the workability of the user is improved as compared with, for example, a case where the annotation region 301 is specified by performing a so-called drag operation.

Specifically, the display controller 112 according to this modification executes the object recognition processing and the boundary recognition processing on the first image IM1 (for example, the A image) and detects the first object included in the first image IM1. For example, the display controller 112 detects that the first image IM1 includes the first object such as the first ventilator object V1, the first window object W1, or the second window object W2. Next, the display controller 112 executes similar processing on the second image IM2 (for example, the B image) and detects the second object included in the second image IM2. For example, the display controller 112 detects that the second image IM2 includes the second object such as the second ventilator object V2, the third window object W3, or the fourth window object W4. Then, the display controller 112 distinguishes the region in which the first object is drawn from the region in which the first object is not drawn and displays the first image IM1 on the display 23 and distinguishes the region in which the second object is drawn from the region in which the second object is not drawn and displays the second image IM2 on the display 23. In this way, the display controller 112 highlights that the region in which the first object is drawn and the region in which the second object is drawn are annotation region candidates.

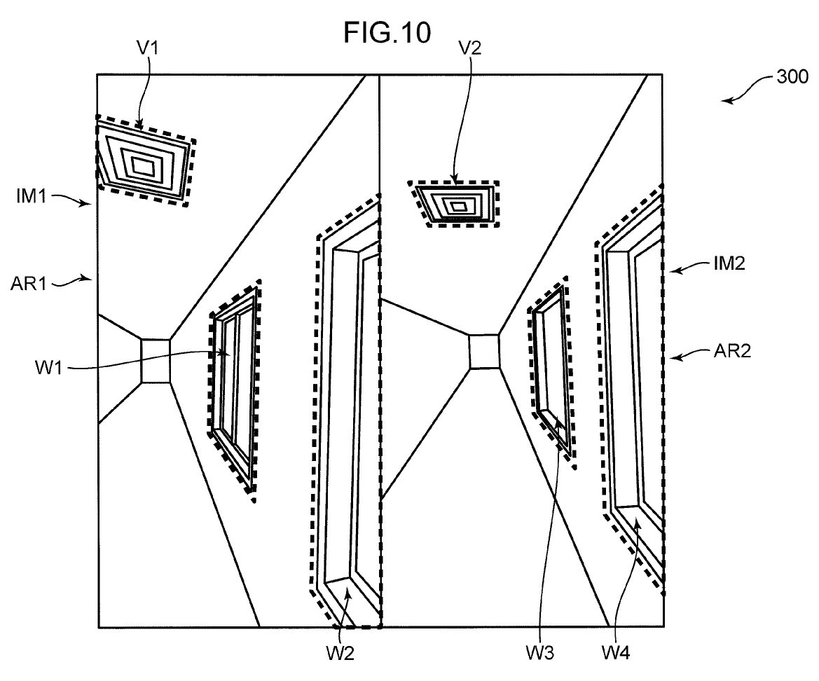

FIG. 10 is a diagram illustrating the comparison screen 300 according to this modification. In the example illustrated in FIG. 10, contour lines are drawn around the first ventilator object V1, the first window object W1, and the second window object W2 detected as the first objects. That is, the region in which the first object is drawn is displayed in a highlighted manner. In the example illustrated in FIG. 10, contour lines are drawn around the second ventilator object V2, the third window object W3, and the fourth window object W4. That is, the region in which the second object is drawn is displayed in a highlighted manner. In this way, the user can intuitively understand that the regions in which the first object and the second object are drawn are the annotation region candidates.

Then, the display controller 112 draws a region selected by the user among these annotation region candidates as the annotation region 301. For example, if the region in which the first window object W1 is drawn is selected, the display controller 112 displays a bounding box or the like in a superimposed manner on a periphery of the first window object W1.

The user may specify the annotation region 301 and the corresponding region 302 corresponding to the annotation region 301 by selecting a plurality of mutually corresponding annotation region candidates. For example, in a case where the comparison screen 300 illustrated in FIG. 10 is displayed, the user selects a region in which the first window object W1 is drawn by clicking with the mouse or the like. Subsequently, the user selects, for example, a region in which the third window object W3 is drawn by clicking with the mouse or the like. In this way, the user associates the region in which the first window object W1 is drawn with the region in which the third window object W3 is drawn. The information terminal 20 having received this instruction transmits the instruction to the server 10. Then, the display controller 112 displays the first window object W1 on the display 23 as the annotation region 301 and displays the third window object W3 on the display 23 as the corresponding region 302. For example, a bounding box surrounding the periphery of the first window object W1 is displayed in a superimposed manner on the first image IM1, and a bounding box surrounding the periphery of the third window object W3 is displayed in a superimposed manner on the second image IM2.

(2) In the first embodiment, an example has been described in which the corresponding region 302 is identified from the second image IM2 on the basis of one of the image information of the annotation region 301 or the positional relationship of the annotation region 301 in the first image IM1 and on the basis of the second image IM2. Alternatively, the corresponding region 302 may be identified from the second image IM2 on the basis of both of the image information of the annotation region 301 and the positional relationship of the annotation region 301 in the first image IM1 and on the basis of the second image IM2. For example, the identifier 114 may acquire, as the first feature amount, a feature vector indicating a color, a shape, a size, and the like of an object existing in the annotation region 301 and a feature vector indicating a positional relationship between a position of the annotation region 301 in the first image IM1 and positions of various objects in the first image IM1. In this case, the identifier 114 may acquire, as the second feature amount, a feature vector indicating a color, a shape, and a size of an object included in the corresponding region candidate, and a feature vector indicating a positional relationship between positions of various objects appearing in the second image IM2 and positions of the corresponding region candidate.

(3) In the above embodiment, an example has been described in which the color, shape, and size of the object included in the annotation region 301 are acquired as the image information of the annotation region 301. However, the image information of the annotation region 301 is not limited to this example. For example, the identifier 114 may acquire, as the image information, a pixel value of each pixel constituting the annotation region 301, the arrangement of the pixels, and information that can be acquired from the pixel value and the arrangements.

(4) In the above embodiment, an example has been described in which the user specifies a predetermined region in the A image as the annotation region 301. However, the user may specify a predetermined region in the B image as the annotation region 301. In this case, the B image is relevant to the first image IM1, and the A image is relevant to the second image IM2.

(5) In the above embodiment, an example has been described in which the user specifies the annotation region 301 after the A image and the B image are displayed on the display 23. However, the annotation region 301 may be specified in advance. That is, the processing illustrated in step S2 in FIG. 3 may be executed before the processing of step S1.

The present disclosure is useful in the technical field of displaying an image.

1. An information processing method performed by a computer , the method comprising:
displaying a first image and a second image different from the first image on a same screen of a display;
detecting a specified region specified by a user and included in the first image;
identifying a corresponding region corresponding to the specified region from the second image on a basis of the second image and at least one of image information of the specified region and a positional relationship of the specified region in the first image; and
displaying the corresponding region in the second image on the display.

2. The information processing method according to claim 1, wherein
identifying the corresponding region includes
acquiring a first feature amount on a basis of at least one of image information of the specified region and a positional relationship of the specified region in the first image,
identifying a corresponding region candidate from the second image on the basis of the first feature amount,
acquiring a second feature amount of the corresponding region candidate, and determining whether a similarity between the first feature amount and the second feature amount exceeds a threshold value predetermined, and
identifying a corresponding region candidate having a second feature amount in which the similarity exceeds the threshold value as the corresponding region.

3. The information processing method according to claim 2, wherein
identifying the corresponding region from the second image includes, in a case where a corresponding region candidate having the second feature amount in which the similarity exceeds the threshold value does not exist in a first display region displayed on the display of the second image,
receiving an instruction to display, on the display, a second display region different from the first display region of the second image, and
identifying the corresponding region from the second display region.

4. The information processing method according to claim 3, wherein
identifying the corresponding region from the second image includes, in a case where the corresponding region candidate having the second feature amount in which the similarity exceeds the threshold value does not exist in the second image,
displaying, on the display as the second image, a substitute image different from an image displayed on the display as the second image, and
identifying the corresponding region from the substitute image.

5. The information processing method according to claim 4, wherein
identifying the corresponding region includes, in a case where the corresponding region candidate having the second feature amount in which the similarity exceeds the threshold value does not exist,
acquiring first information including an imaging position and an imaging direction when the first image is captured, and an angle of view of a display region of the first image displayed on the display in a left-right direction,
acquiring second information including an imaging position, an imaging direction, and an angle of view of the first display region in the left-right direction when the second image is captured,
estimating the corresponding region from the second image on a basis of the first information and the second information.

6. The information processing method according to claim 1, further comprising
detecting a first object included in the first image; and
detecting a second object included in the second image,
wherein displaying the first image and the second image on the same screen of the display includes distinguishing a region in which the first object is drawn from a region in which the first object is not drawn and displaying the first image on the display, displaying the second image on the display and distinguishing a region in which the second object is drawn from a region in which the second object is not drawn, and thus highlighting that the region in which the first object is drawn and the region in which the second object is drawn are regions to be candidates for the specified region.

7. An information processing device comprising a processor, wherein
the processor executes
displaying a first image and a second image different from the first image on a same screen of a display,
detecting a specified region specified by a user and included in the first image,
identifying a corresponding region corresponding to the specified region from the second image on a basis of the second image and at least one of image information of the specified region and a positional relationship of the specified region in the first image, and
displaying the corresponding region in the second image on the display.

8. A non-transitory computer readable recording medium storing an information processing program for causing a computer to execute
displaying a first image and a second image different from the first image on a same screen of a display,
detecting a specified region specified by a user and included in the first image,
identifying a corresponding region corresponding to the specified region from the second image on a basis of the second image and at least one of image information of the specified region and a positional relationship of the specified region in the first image, and
displaying the corresponding region in the second image on the display.
